(19) United States
(12) Patent Application Publication
(10) Pub. No.: US 2025/0342152 A1
(43) Pub. Date: Nov. 6, 2025

(54) DYNAMIC PRIORITIZATION OF CONTEXT AND SIMILARITY SEARCH FOR HETEROGENOUS DATA SOURCES

(71) Applicant: Cisco Technology, Inc., San Jose, CA (US)

(72) Inventors: Carlos Goncalves Pereira, Carlsbad, CA (US); Marcelo Yannuzzi, Nuvilly (CH); Arash Salarian, Chardonne (CH); Herve Muyal, Gland (CH); Jean Andrei Diaconu, Gaillard (FR)

(21) Appl. No.: 18/652,041

(22) Filed: May 1, 2024

(51) Int. Cl. G06F 16/2452; G06F 16/242

(52) U.S. Cl. CPC G06F 16/24522; G06F 16/2438

(57) ABSTRACT

Techniques and mechanisms are provided for enabling dynamic prioritization during similarity search processes across vectorized knowledgebases (KB) where the prioritization may depend on specific events and/or time windows between data updates to provide weighting to similar text or data items to raise or lower priority of various text or data items for return in response to queries. More particularly, the techniques and mechanisms described herein provide for bringing proprietary and possibly silo-ed data models/sources and schemas into a common and consistent embedding that allows for dynamic prioritization of such embeddings depending on specific events and/or time windows between updates to the disparate data sources.

### TECHNICAL FIELD

The present disclosure relates generally to dynamic prioritization of data responsive to similarity search processes. More specifically, the techniques relate to dynamically prioritizing data for similarity search processes based on events associated with the data and/or based on timing associated with the data.

### BACKGROUND

Large language models (LLM) have become very powerful tools for text generation, text and data summarization, question/answer processing, conversations (e.g., human-to-machine and vice versa), and more. LLMs are trained by providing them with hundreds of thousands (or more) of content items (e.g., text and data). LLMs are capable of general-purpose language generation by taking a text or data input and by predicting the next word, phrase, or data item. LLMs develop these techniques/skills by learning statistical relationships between words or phrases. That is, by learning vast amounts of text and data and statistical relationships between words, phrases, and data, an LLM can predict and generate language. For example, if presented with the phrase “have a nice . . . ,” a trained LLM may predict that the next word should be “day” so that the LLM may predict an appropriate phrase being attempted by the user is “have a nice day.” In more advanced cases, an LLM may be asked to prepare a narrative or story on a particular topic. In response to a user query, the LLM may query its vast knowledge of information and relationships between words and phrases to predict, generate and present a narrative of varying lengths in response the user's query. Outside basic text generation, such a powerful tool allows users to query the LLM for assistance with a variety of complex issues. For example, in the area of cybersecurity management, a security operations (SecOps) person may query an LLM with a question about a security concern, and the LLM will return an answer that will allow the security operations person to address the problem. For example, the security operations person may ask “Why am I receiving security alarm error code 345?” Based on the training received by the LLM, the LLM may return one or more responses, for example, “Restart your firewall router” or “Check the connectivity of the data protection server with the router.” That is, by querying an LLM pre-trained with vast amounts of text and data and relationships among words, phrases or data items associated with a more specific area of concern, for example, cybersecurity management, the pre-trained LLM may predict and provide an answer to the query.

Unfortunately, the ability of an LLM to provide such helpful text generation or answers to questions/queries, depends on whether the LLM has been trained with sufficient text/data to allow it to predict and generate a useful response. That is, if the LLM has not been pre-trained with sufficient information to allow it to predict and generate text or data responsive to the question/query, then it will either fail to return a response or it will generate a best response based on training that may be lacking in usefulness or inappropriate altogether. Such lacking or inappropriate LLM responses are sometimes referred to as “hallucinations” where the LLM generates an unresponsive or nonsensical response based on its inability to predict a useful response owing to a lacking of data provided to the LLM during pre-training. In some situations, a pre-trained LLM may have received substantial training, but at the time of a query, the training text/data on which the LLM has been trained has been updated after the LLM was trained, or two or more similar text or data items available to the LLM may have varying significance to a given query where one of the similar text or data items should be more responsive to the query either in terms of updates or in terms of the timing associated with the one of the similar text or data items. For example, a given text or data item may be more recent than a similar text or data item or may have received one or more updates as compared to a similar text or data item. In such cases, it is advantageous to consider the temporal and/or contextual nature of similar text or data items when deciding a priority with which they are utilized by the LLM for generating a response to a query.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1A illustrates a system architecture for updating a large language model based on post-training events or information and for dynamic prioritization of similarity search processes in vectorized knowledgebases.

FIG. 1B illustrates a continuation of the system architecture depicted in FIG. 1A for updating a large language model based on post-training events or information and for dynamic prioritization of similarity search processes in vectorized knowledgebases.

FIG. 2 illustrates a flow diagram of an example method for updating a large language model based on post-training events or information and for dynamic prioritization of similarity search processes in vectorized knowledgebases. For purposes of example, the method illustrated in FIG. 2 shows updating the large language model and dynamic prioritization based on cybersecurity information updates and searches.

FIG. 3 illustrates a flow diagram of an example generic method for dynamic prioritization of similarity search processes in vectorized knowledgebases.

FIG. 4 illustrates a flow diagram of an example method for dynamically updating a large language model (LLM) where a data item is received for updating the LLM.

FIG. 5 illustrates a flow diagram of an example system for dynamically prioritizing similarity searches directed to a large language model (LLM) by distinguishing between same or similar data items in a large language model based on weightings applied to same or similar data items.

FIG. 6 is a computer architecture diagram showing an illustrative computer hardware architecture for implementing a computing system/device that can be utilized to implement aspects of the various technologies presented herein.

### DESCRIPTION OF EXAMPLE EMBODIMENTS

### Overview

The present disclosure relates generally to enabling dynamic prioritization during similarity search processes across vectorized knowledgebases (KB) associated with large language models (LLM) where the prioritization may depend on specific events and/or time windows between data updates to provide weighting to similar text or data items to raise or lower priority of various text or data items for return in response to queries.

A system to perform techniques described herein may include a chunking, tokenization and embedding (CTE) component operative to receive a first data item from a data source to be added to a large language model (LLM) and to receive descriptive information about the first data item and about an instance of the first data item. The CTE component is further operative to assign a first weighting to the first data item based on the descriptive information about the first data item and to assign a second weighting to the instance of the first data item based on the descriptive information about the instance of the first data item. The CTE component may pass a query to a dynamically prioritized similarity search (DPSS) component directed to the first data item and to the instance of the first data item. The DPSS component is operative to perform a similarity search and context retrieval from one or more vectorized knowledgebases associated with the first data item and the instance of the first data item and to determine which of the first or second weightings is a higher weighting.

In addition, the CTE component is further operative to generate a first embedding in a first vectorized knowledgebase, the first embedding associated with the first data item and to bind the first embedding to the first data item with augmented metadata associated with the first weighting assigned to the first data item. The CTE component is further operative to generate a second embedding in a second vectorized knowledgebase, the second embedding associated with the instance of the first data item and to bind the second embedding to the instance of the first data item with augmented metadata associated with the second weighting assigned to the instance of the data item. According to examples, the CTE component may receive a query applicable to the first data item and to the instance of the first data item. In response, the CTE component may forward the query to the DPSS component. The DPSS component may query the first and second vectorized knowledgebases for the first and second embeddings and return the first and second weightings. In response, the DPSS component may return one of the first data item or the instance of the first data item associated with the higher weighting and may append the query with augmented context information associated with the one of the first data item or the instance of the first data item associated with the higher weighting. The DPSS component may then pass the query with the augmented context information to the LLM.

A method to perform the techniques described herein may include receiving a first data item to be added to a large language model (LLM) and determining that an instance of the first data item is present in the LLM. A first weighting is assigned to the first data item to be added to the LLM and a second weighting is assigned to the instance of the first data item. A determination is made as to which of the first or second weightings is a higher weighting. The LLM is updated with one of the first data item or the instance of the first data item associated with the higher weighting. According to examples assigning a first weighting to the first data item to be added to the LLM includes generating a first embedding in a first vectorized database, the first embedding associated with the first data item. The first embedding is bound to the first data item with augmented metadata associated with the first weighting assigned to the first data item. Assigning a second weighting to the instance of the first data item includes generating a second embedding in a second vectorized database, the second embedding associated with the instance of the first data item. The second embedding is bound to the instance of the first data item with augmented metadata associated with the second weighting assigned to the instance of the data item. When a query is received that is applicable to the first data item and to the instance of the first data item, the first and second vectorized databases are queried for the first and second embeddings. In response, the first and second weightings are returned and the first data item or the instance of the first data item associated with the higher weighting is returned.

Additionally, the techniques described herein may be performed by a device having non-transitory computer-readable media storing computer-executable instructions that, when executed by one or more processors, performs the method described above.

### EXAMPLE EMBODIMENTS

As briefly discussed above, large language models (LLM) provide highly useful functionality by providing for text generation, text and/or data summarization, question/answer processing, human-to-machine conversation, and more. However, while LLMs are pre-trained with vast amounts of information (e.g., text, data and statistical and inferential relationships between words, phrases and data) and are capable of providing these functionalities, LLMs suffer from informational limitations caused by lack of specific or recent information (e.g., information that was not part of data used to pre-train the LLM). Such lack of specific and/or recent information available to an LLM may cause the LLM to generate so-called “hallucinations” where the LLM returns an inaccurate, inappropriate or nonsensical response to a query owing to a lack of information available to the LLM for better query processing. Attempts have been made to augment LLM's with contextual information to correct such issues, but such attempts have several limitations as data and knowledgebases associated with LLM's have equal weighting during similarity search processes. That is, prior similarity search techniques focused on finding the top k matches across knowledgebases (KB) without considering elements such as temporal relevance of embeddings in the KBs or priority based on updated information (e.g., a recent event associated with a given text or data item, signal, alarm, application component update, etc.).

These issues are worsened when data used for pre-training an LLM comes from a number of disparate heterogenous data sources that may be separately operated apart from each other or may be operated according to proprietary systems (e.g., operated according to different schemas, coding, security protocols, etc.). Text/data from disparate data sources or operated according to different or proprietary systems may prevent data from such sources from being fed into the LLM in a manner that allows the LLM to provide useful query responses generated from data across disparate text or data components provided from the disparate and heterogenous data sources.

For example, the cybersecurity industry has recognized the power of pre-trained large language models (LLMs) and the advantages of natural language interfaces to augment the productivity of security teams. However, the data required to unlock such productivity often remains not only silo-ed, but it is often stored using proprietary models and schemas that have never been used for pre-training an LLM. For instance, a Cloud-Native Application Protection Platform (CNAPP) may use a graph database and a proprietary schema to model the various assets, their relationships, properties, and threats across the entire CNAPP stack, while a detection and response solution (e.g., an xDR system, such as EDR or CNDR) may use a proprietary data lake and querying method to store and query the various signals obtained during the detection phases as well as their corresponding responses. Indeed, many enterprises rely on different products and/or solution providers for CNAPP and xDR, so even having a common embedding across these silos is a challenge. In addition, the update of these various data sources may typically take place at different frequencies (e.g., once or twice a day for a graph database in CNAPP, while the update rate in a data lake supporting xDR may be several orders of magnitude higher). While these heterogeneous data sources may be used to finetune LLMs and/or to populate vectorized knowledgebases in order to augment the context during Retrieval Augmented Generation (RAG) flows, the temporal relevance of these knowledgebases and their corresponding contents varies with such updates.

This disclosure describes techniques and mechanisms for enabling dynamic prioritization during similarity search processes across vectorized knowledgebases (KB) where the prioritization may depend on specific events and/or time windows between data updates to provide weighting to similar text or data items to raise or lower priority of various text or data items for return in response to queries. More particularly, the techniques and mechanisms described herein provide for bringing proprietary and possibly silo-ed data models/sources and schemas into a common and consistent embedding that allows for dynamic prioritization of such embeddings depending on specific events and/or time windows between updates to the disparate data sources.

According to examples, and as will be described in further detail below, queries directed to a pre-trained or finetuned LLM may take advantage of finetuning of the pre-trained LLM where finetuning enhances or cures behavioral gaps in the pre-trained LLM or finetuned LLM owing to gaps between when the pre-trained or finetuned LLM was last trained or finetuned. That is, if a pre-trained LLM was first trained or was finetuned two years ago, gaps in the skill set of the pre-trained LLM or previously finetuned LLM may exist based on information now available for the LLM that was not fed into the pre-trained LLM or previously finetuned LLM. Such behavioral gaps (e.g., lack of a skill) typically lie on the lack of training to acquire new or specific skills, for example, detecting specific features based on a query or on the prompted data itself. Finetuning the pre-trained or previously trained LLM with information updates typically addresses this problem where the finetuning with updated information allows the pre-trained or previously finetuned LLM to learn a new skill. On the other hand, according to examples of the present disclosure, RAG and other context augmentation techniques described herein may utilize information updates to mitigate informational gaps in pre-trained LLMs or previously finetuned LLMs, for example, to provide updated information to an LLM previously trained or finetuned but lacking needed information since the pre-training or last finetuning.

According to techniques and mechanisms described herein, data from a number of disparate and/or heterogenous data sources is fed into a pre-trained LLM or previously finetuned LLM for updating the pre-trained LLM or previously finetuned LLM to update skill sets of the pre-trained LLM or previously finetuned LLM, as described above. In addition to updated data from the disparate and/or heterogenous data sources, if system information about the health of the system (e.g., system vulnerabilities, weaknesses, alarms, other similar events) is needed by the LLM to enhance search responses, such system health information may also be fed into the LLM for finetuning the LLM. However, the aforementioned problem of common embeddings across such updated information and a lack of weighting associated with newly received data as compared to previously trained data may prevent or lessen the ability to perform prioritized searches against similar text/data items in the LLM or finetuned LLM because the LLM or finetuned LLM may return a response that is less contextually or temporally relevant than another similar response.

In order to account for any disparate and/or heterogenous data issues associated with updated data from the disparate data sources and updated system health data, according to additional techniques and mechanisms of this disclosure, the updated data from the heterogenous data sources and/or system health data is also passed to a chunking, tokenization and embedding (CTE) component. According to examples, the CTE component enables normalization of the updated data and system health information by generating a common embedding across heterogenous data and system health information when the common embeddings are maintained and accessed via one or more vectorized knowledgebases. Generating a common embedding across heterogenous data and system health information will allow subsequent queries to a finetuned LLM to associate data from heterogenous data sources and system health information across the common embeddings for returning a query response that utilizes the data from the heterogenous data sources and system health data. According to examples, generating the common embeddings, as described, enables a retrieval augmented generation (RAG) flow in association with one or more knowledgebases (KB) to provide context to queries directed to the finetuned LLM to cure informational gaps in information available to the LLM since its pre-training or previous finetuning.

The techniques and mechanisms described herein enable assignment of different weights to various occurrences of the same or similar string, and therefore, enable enhanced similarity searches for top k matches associated with same or similar strings. For example, the string “{jndi: ldap:// . . . }” may be assigned a lower weight when found in documentation and examples in the knowledgebases (KB) or in previous information provided by a CNAPP solution (e.g., several hours ago during the last scan), while it may be assigned a higher weight when coming from a new log entry from a given data source. In addition, the nature of the entries stored in a vectorized database also impact search. For example, a newly discovered vulnerability (e.g., a new CVE) may carry less risk, and therefore, may be less relevant than an update to the Cybersecurity and Infrastructure Security Agency (CISA) catalog of Known Exploitable Vulnerabilities (KEVs). Thus, the various occurrences of a given string may be weighted differently depending on the origin or source of information.

According to examples, the CTE component may allow binding of the embeddings stored in vectorized databases with augmented metadata, thereby enabling the assignment of dynamic weights depending on temporal, and/or origin, and/or other contextual factors. In one example, the weights may not affect the embeddings. That is, the embeddings may be created and managed apart from the CTE component so the metadata binding the embeddings to their corresponding priorities or weights may be handled and maintained externally to the embeddings themselves. Such metadata may be used by a dynamically prioritized similarity search (DPSS) component. Such metadata and the corresponding bindings may be persisted by the DPSS component, the CTE component, the vector databases themselves, or a combination thereof.

According to examples, when a search query is received directed to the LLM (or finetuned LLM), the query may be passed first to the CTE component for leveraging the RAG (and associated knowledgebases). The CTE component may forward the queries to the DPSS component, which may in turn perform a similarity search and context retrieval from the vectorized KBs. According to one example, the DPSS component may assist the CTE component during the embedding and storage of information in the KBs. In such case, the DPSS component may support and maintain the metadata and associated bindings. The query may be temporarily stored while context augmentation information is acquired via retrieval augmented generation (RAG) flows described herein. Subsequently, the query may be combined with augmented context provided via the RAG KBs 138. The appended query (combined query plus augmented context information) may then be passed to the finetuned LLM for a response.

Various KBs may be available to the DPSS component. According to examples, the extent to which various KBs are available to the DPSS component may depend on how different silo-ed systems may be associated with each other as part of a common embedding platform. The DPSS component may query the KBs using one or more of available KBs. For example, a first KB may store embeddings associated with temporally relevant log entries, while a second KB may store embeddings associated with product (e.g., software application) documentation. Thus, the occurrence of a string “{jndi: ldap:// . . . }” may be assigned a higher weight in the first KB than in the second KB.

According to one example, the weights assigned to strings in the one or more KBs may be captured by different decay functions. According to another embodiment, the weights may be assigned and maintained at a more granular level, thereby enabling the use of various weights on a per KB basis. In some cases, the weights may be automatically reset after a period, or they may converge to the same value, or they may remain with different values until a condition is met (e.g., a remediation action, application change, etc. is logged). New embeddings inserted in the KBs may trigger notifications and continuously feed the metadata and bindings maintained by the DPSS component into the finetuned LLM. These updates may be used as conditions to either recompute or reset the weights. In one example, such notifications may be sent by the CTE component for insertion into the KBs.

The DPSS component may retrieve the various matches to a query found in the various KBs and compute the top k matches based on their priority as a function of temporal conditions or weightings applied to potential responsive strings. For example, the top k matches may be computed using a function of time (e.g., Top_k(P(t)). In the case of updates regarding a new CVE versus a new KEV, the top k matches may also be computed based on the weight of the events (e.g., Top_k(P (e)). They may also be computed as a function both of time and the weight of the events (e.g., Top_k(P(t,e)).

According to examples, based on the DPSS component performance of a prioritized similarity search, the result of the prioritized similarity search and augmented context may be returned. The augmented context provided by the DPSS component may be appended to the original search query and may be sent as an augmented query to the finetuned LLM. An answer generated by the finetuned LLM then may be returned to the requesting user (e.g., SecOps person) that issued the query. According to another example, the CTE component, the DPSS component and the RAG KBs in concert may exercise control on the level of prioritization associated with one or more text/data strings. According to examples, a control function may be provided via the prompt interface, which may allow a requesting user to select a level of prioritization used during RAG processes. For example, use no priority at all, or use the Top_k(P(t)), or use the Top_k(P (e)), or use the Top_k(P(t,e)), or other examples of prioritization that may be requested by the user.

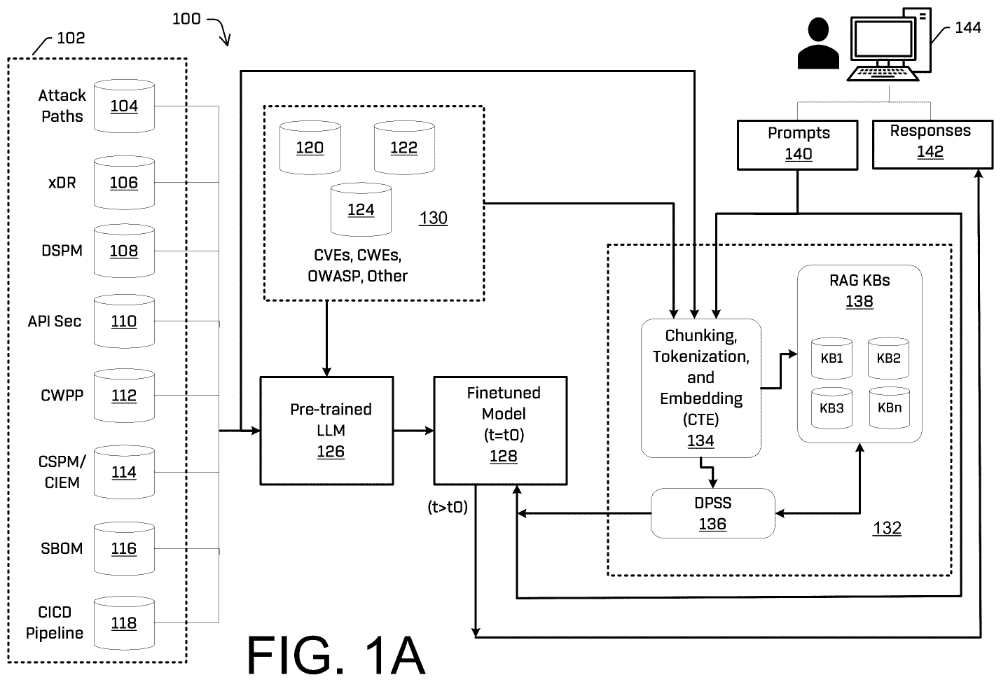

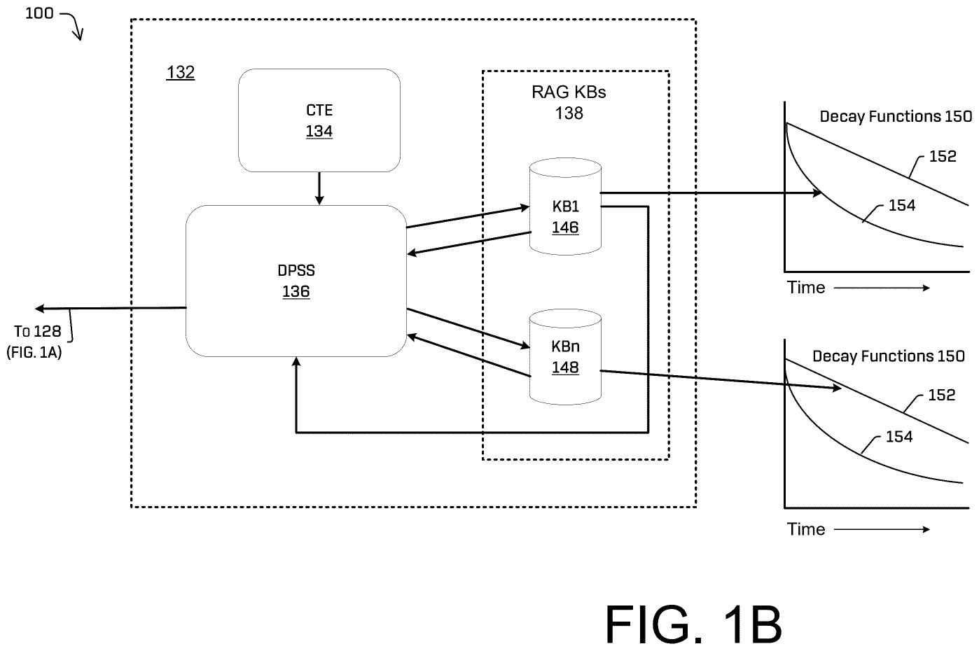

FIG. 1A illustrates a system architecture of a dynamic search system 100 for updating a large language model based on post-training events or information and for dynamic prioritization of similarity search processes in vectorized knowledgebases. For purposes of example, the system architecture illustrated in FIG. 1A is described with reference to techniques and mechanisms of the present disclosure utilized in a cybersecurity management environment. As will be readily understood, techniques and mechanisms described herein are equally useful in dynamic prioritization of context and similarity search associated with heterogenous data sources associated with a vast number of text and/or data environments.

Referring in the FIG. 1A, the left side of FIG. 1A shows a data source collection 102. For purposes of example, the data source collection 102 is illustrated as containing a number of heterogenous cybersecurity-oriented data sources 104-118 where each data source may include text and/or data that has been fed into a large language model (LLM) or from which updated information may be needed in the LLM so that subsequent queries to the LLM will result in useful responsive information. As mentioned above, however, the heterogenous data sources illustrated in the data source collection 102 are for purposes of example only and are not limiting of other types of data that may be included in the LLM. For example, instead of cybersecurity-oriented data sources 104-118, heterogenous data sources may be associated with a variety of topics such as engineering systems, entertainment systems, manufacturing systems, research systems, food and drug systems, and the like. For example, instead of cybersecurity-oriented systems, the data collection 102 may have a number of data sources associated with entertainment sources, such as different content providers. Each separate data source may be structured and accessible according to individual proprietary coding and security frameworks. According to examples of the present disclosure, text and/or data from such heterogenous data sources may be fed into and utilized via the large language model (LLM) 126.

Referring still to the data source collection 102, the example cybersecurity-oriented data sources 104-118 may contain text and/or data that support different security functions and that persists relevant data in heterogenous ways and formats of a Cloud Native Application Protection Platform (CNAPP). As understood by those skilled in the art, Cloud Native Application Protection Platforms may include security and compliance information/capabilities to prevent, detect and respond to cloud security threats. According to examples, the CNAPP may integrate multiple cloud security solutions that have been traditionally silo-ed for enabling protection of a cloud application footprint for cloud-based systems.

The attacks path data source 104 may include information representative of one or more paths a malicious actor may use for exploiting a vulnerability or weakness in a computing system or application. The extended detection and response (xDR) data source 106 may include data associated with multiple security layers, for example, email, endpoint, server, cloud workload and network layers and allows for faster detection and response for security analysis and solution. The data security posture management (DSPM) data source 108 may include information associated with where sensitive data is maintained, who or what has access to that data, how it has been used, and the security posture for a given system or solution. The application programming interface (API) security data source 110 may include vulnerabilities and information associated with interfaces between two or more applications, services or systems that may be of particular interest in a cybersecurity management environment. As understood by those skilled in the art, APIs define how two or more applications, services or systems communicate requests and responses between disparate applications and services.

The cloud workload protection platform (CWPP) 112 may contain vulnerabilities information associated with a unified cloud security solution that offer continuous threat monitoring for cloud workloads across different types of cloud environments. The CWPP data source 112 may automatically provide and utilize security features to monitor activity across online and visible locations such as the servers for a virtual system. Some system vulnerabilities may be found as part of the cloud security posture management (CSPM) and/or the cloud infrastructure entitlement management (CIEM) data source 114. The software bill of materials (SBOM) 116 may include a comprehensive list of all software components, dependencies, the metadata associated with a particular application, or an inventory of all building blocks that makeup a software application. The continuous integration and continuous delivery/deployment (CICD) pipeline data source 118 may include information regarding software and/or application code changes maintained in a central repository. As should be understood, the data sources 104-118 are for purposes of example and are not limiting of other data sources that may be utilized in association with a cybersecurity management system or other data sources that may be utilized in one or more other systems for which aspects of the present disclosure may be available.

Referring still to FIG. 1A, the pre-trained large language model (LLM) 126 is illustrative of an LLM that has been previously trained with large amounts of text and/or data to enable responses to queries, as described herein. The LLM 126 may be a generic model with large amounts of text and/or data to which queries may be directed for a number of topics, or the LLM 126 may contain large amounts of text and/or data associated with a specific problem or topic, for example, cybersecurity management. The finetuned LLM 128 is illustrative of an updated instance of the LLM 126. According to examples, the finetuned LLM 128 is updated from the pretrained LLM 126 by receiving additional training in the form of updated text/data from the data sources 104-118, vulnerabilities and warnings provided by the vulnerabilities, weaknesses and system health source 130 (discussed below) and from the data augmentation and prioritized search system 132 (discussed below).

Referring still to FIG. 1A, the vulnerabilities, warnings and system health source 130 may include one or more sources of information that may be integrated with each other or may operate as heterogenous and disparate information sources that may provide vulnerability, weaknesses and system health information associated with a system, for example, a cybersecurity management system. The vulnerabilities, weaknesses and system health information may be used, as described below, to update LLM 126 to a finetuned LLM 128. For example, the common vulnerabilities and exposures (CVE) data source 120 may include a system that provides for publicly sharing information on cybersecurity vulnerabilities and exposures of a given system or application. The CVE data source 120 may include known vulnerabilities and/or exposures that may be associated with one or more of the data sources 104-118, illustrated and described above. The common weaknesses enumeration (CWE) data source 122 may include a universal online dictionary of weaknesses that have been found in systems of various types, for example, software systems, data management systems, cybersecurity management systems, and the like. The open worldwide application security project (OWASP) data source 124 may operate as an open model and data source/service in which information may be provided by various systems and users that may be utilized in a cybersecurity management environment. As described below, information from the CVE 120, CWE 122 and OWASP 124 may be utilized for finetuning the pre-trained LLM 126 either by passing information from these systems/services directly to the LLM 126 or by feeding information from these systems/services through the data augmentation and prioritized search system 132, described below. As should be appreciated the CVE 120, CWE 122 and OWASP 124 are for purposes of example and are not limiting of other data sources or systems that may be utilized for providing updated information to the LLM 126 or to the data augmentation and prioritized search system 132 (discussed below).

Referring still to FIG. 1A, the data augmentation and prioritized search system 132 may include components for receiving text and/or data from the data sources 104-118 and vulnerabilities, weaknesses and system health data from the vulnerabilities, weaknesses and system health source 130. The data augmentation and prioritized search system 132 includes a chunking, tokenization and embedding (CTE) component 134. According to examples, the CTE component 134 may receive information from one or more of the data sources 104-118 and from one of more of the CVE 120, CWE 122 and OWASP 124. At the CTE 134, received text and/or data may be passed through a chunking and tokenization process where lengthy strings of text or data may be broken into smaller units that are more manageable for subsequent tokenization and application of embeddings for representing the received text or data in the finetuned LLM 128 or in one or more knowledgebases in the RAG KBs 138. For example, a lengthy string that may include sensitive information such as a serial number, cypher, or the like, may be replaced with a shorter, more manageable and/or less sensitive string or token for subsequent use via the finetuned LLM 128. An embedding process may be included with the CTE 134 for generating continuous vector representations of words or tokens that capture the semantic meanings of the words or tokens. The LLM 126, the finetuned LLM 128 or one or more knowledgebases in the RAG KBs 138 may use the embeddings for understanding and utilizing relationships between words and/or tokens for providing natural language responses 142.

Referring still to the data augmentation and prioritized search system 132, one or more retrieval augmented generation (RAG) knowledgebases (KB) 138 may be provided. According to examples, retrieval augmented generation allows for retrieving information from a knowledgebase to assist an LLM such as the LLM 126 and/or the finetuned LLM 128 to find the most accurate and up-to-date information in response to a query. According to examples of the present disclosure, one or more text or data items received from the data sources 104-118 and/or the vulnerabilities, weaknesses and system health data from the vulnerabilities, weaknesses, and system health source 130 may receive embeddings via the CTE 134 and may be added to the one or more RAG vectorized knowledgebases (KB) 138.

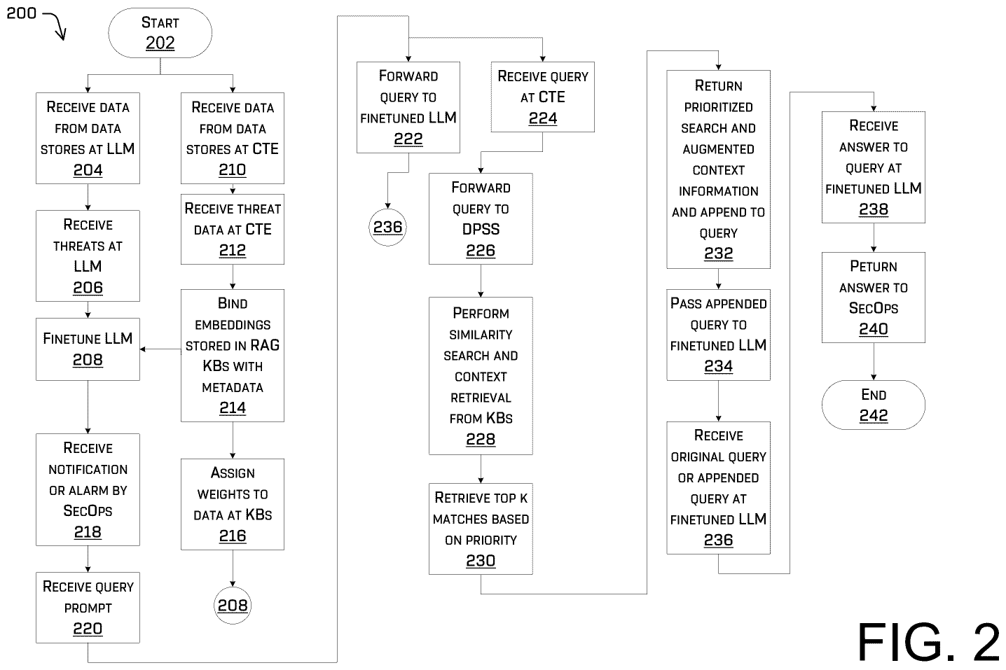

Referring still to FIG. 1A, the data augmentation and prioritized search system 132 includes a dynamically prioritized similarity search (DPSS) component 136. According to examples, the DPSS component 136 may receive queries via a prompt interface 140 (i.e., queries from a user via the CTE component 134) as well as information from the RAG KBs 138. Information received by the DPSS component 136 may be used to update the finetuned LLM 128, as illustrated in FIG. 1A, as described below with reference to FIG. 2.

As described above, data from the one or more data sources 104-118, the vulnerabilities, weaknesses, and system health source 130 may be used for finetuning the LLM 126 into a finetuned LLM 128. According to examples finetuning a large language model includes teaching new techniques/skills to the model to update and enhance the model's responsiveness to queries. For example, new vulnerabilities (CVEs) and weaknesses (CWEs) may arise; the application or its configuration may change requiring modification of an associated application asset graph; new elements may be added to the CICD pipeline; new data sources and/or sensitive data may now be used (and may be added to the data sources 104-118); new API versions may be released, etc. As illustrated in FIG. 1A, the finetuning process of the finetuned LLM 128 may be completed at an initial time (t=t0). Once updated techniques/skills are learned by the finetuned LLM 128, the model may be able to carry out various tasks leveraging the newly learned techniques/skills after the finetuning process is complete (at time t>t0).

In response, updated information from the various data sources (104-118) may be continuously fed into a the CTE component 134, along with updated information about CVEs, CWEs, or OWASP threats. The CTE component 134 may enable normalization by generating a common embedding across heterogenous data sources for building a unified RAG service 138 along with the corresponding KBs. As described above, updated information to the CTE component 134 for building a unified RAG service 138 allows the RAG KBs 138 subsequently to provide context augmentation to queries directed to the finetuned LLM 128 as a context augmented query. The context augmented query (i.e., combined received query plus augmented context information) fills informational gaps in the finetuned LLM 128 that exist owing to gaps in information since pre-training of the LLM 126 or the last fine tuning of the LLM 126/LLM 128.

According to examples, the text and/or data inputs that are used to generate embeddings, the various data sources (data sources 104-118, CVEs, CWEs, OWASP information, etc.) may be updated with different frequencies. For example, an application graph database may be updated every 12 or 24 hours (e.g., as part of a CNAPP solution), while the update rate of an application log may be higher. Thus, the temporal relevance of the embeddings varies with such updates. For instance, a malicious payload may be logged (e.g., encoding a Java Naming and Directory Interface or JNDI LDAP lookup, referencing an unexpected or unknown server), with the aim of conducting a log 4j attack. The success of this type of attack depends on the capacity to exploit logs. For example, if the logged entry in a cybersecurity log triggers an alarm (e.g., sent to a SecOps person), an embedding and the subsequent update of the RAG KBs, may enable the user (e.g., SecOps person) to benefit from the finetuned LLM 128 for investigating the alarm. That is, fine tuning the LLM 126 and/or the previously finetuned LLM 128 with updated information to generated a further finetuned LLM 128 allows the finetuned LLM 128 to learn a new skill for handling the example alarm or other query, and context augmentation from the RAG KBs updated via the CTE component from received updates provides information to fill informational gaps in the finetuned LLM for providing a response to the query now that the finetuned LLM 128 has learned a new skill for using the updated information.

Referring still to FIG. 1A, as described above, the techniques and mechanisms described herein enable assignment of different weights to various occurrences of the same or similar string, and therefore, enable enhanced similarity searches for top k matches associated with same or similar strings. For example, the string “{jndi: ldap:// . . . }” may be assigned a lower weight when found in documentation and examples in the knowledgebases (KB) or in previous information provided by a CNAPP solution (e.g., several hours ago during the last scan), while it may be assigned a higher weight when coming from a new log entry from a given data source. In addition, the nature of the entries stored in a vectorized database also impact search. The CTE component 134 may allow binding of the embeddings stored in vectorized databases with augmented metadata, thereby enabling the assignment of dynamic weights depending on temporal, and/or origin, and/or other contextual factors. In one example, the weights may not affect the embeddings. The augmented metadata and the corresponding bindings may be persisted by the DPSS component 136, the CTE component 134, the vector databases in the RAG KBs 138, or a combination thereof.

FIG. 1B is a continuation of the system architecture 100 of FIG. 1A for updating a large language model based on post-training events or information and for dynamic prioritization of similarity search processes in vectorized knowledgebases. As illustrated in FIG. 1B, the relationship among the CTE component 134, the DPSS component 136 and the RAG KBs 138 is further illustrated and described. Various KBs 146, 148 may be available to the DPSS component 136 which may depend on how different silo-ed systems (e.g., data sources 104-118, CVEs 120, CWEs 122, OWASP information 124) may come together as part of a common embedding platform. The DPSS component 136 may query the KBs, using, for example, KB1 and KBn, respectively. For instance, KB1 146 may source embeddings associated with temporally relevant log entries, while KBn 148 may source embeddings associated with product documentation. Thus, the occurrence of a string “{jndi: ldap:// . . . }” may be assigned a higher weight in KB1 than in KBn.

Referring still to FIG. 1B, the weights may be captured by different decay functions 150. For example, using curve 152 for the contents in KB1, while using curve 154 for the contents of KBn. In another embodiment, the weights may be assigned and maintained at a more granular level, thereby enabling the use of various weights on a per KB basis. In some cases, the weights may be automatically reset after a period, or they may converge to the same value, or they may remain with different values until a condition is met (e.g., a remediation action is logged). New embeddings inserted in the KBs may trigger notifications and continuously feed the metadata and bindings maintained by the DPSS component 136.

As described above, in some cases, the weights may be automatically reset after a period, or they may converge to the same value, or they may remain with different values until a condition is met (e.g., a remediation action, application change, etc. is logged). New embeddings inserted in the KBs 146, 148 may trigger notifications and continuously feed the metadata and bindings maintained by the DPSS component 136 into the finetuned LLM. These updates may be used as conditions to either recompute or reset the weights. In one example, such notifications may be sent by the CTE component for insertion into the KBs.

The DPSS component 136 may retrieve the various matches to a query found in the various KBs and compute the top k matches based on their priority as a function of temporal conditions or weightings applied to potential responsive strings. For example, the top k matches may be computed using a function of time (e.g., Top_k(P(t)), or the top k matches may also be computed based on the weight of the events (e.g., Top_k(P (e)). They may also be computed as a function both of time and the weight of the events (e.g., Top_k(P(t,e)). According to examples, the augmented context provided by the DPSS component 136 may be appended to the original search query and may be sent as an augmented query to the finetuned LLM 128.

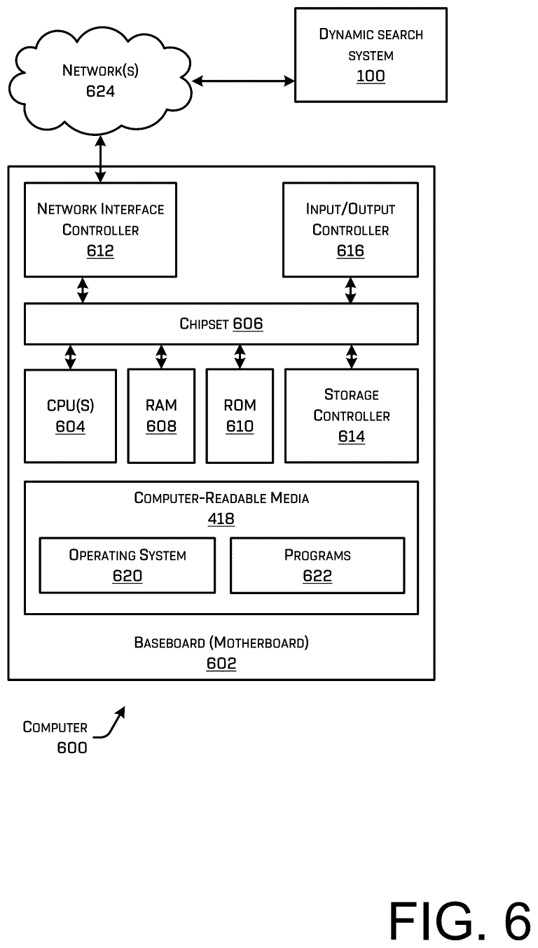

Referring back to FIG. 1A, and as will be described in further detail below with reference to FIGS. 2-5, when a query is received via the prompt interface 140, the query may be temporarily stored at storage 142 (e.g., any suitable storage as described below with reference to FIG. 6). While the query is temporarily stored, it simultaneously may be passed to the CTE component 134 and the RAG KBs 138 for retrieving augmented context information for the query based on updates processed by the CTE component, as described herein. Augmented context from the RAG KBs is then processed by the DPSS component and is combined with the received query to generate the combined prompt (query) plus augmented context 144. The combined prompt (query) plus augmented context 144 then may be passed to the finetuned LLM 128 for a response. As described herein, updates to the finetuned LLM 128 provide for behavioral updates to the LLM 128 (e.g., learning a new skill), and augmented context information from the RAG KBs 138 via the DPSS component 136 provide for informational gap filling for the finetuned LLM 128. Thus, in response to the received query, the LLM 128 will be able to use one or more learned skills on updated information provided via the augmented context information. That is, after updates from the data sources 102 and 130 are used to fine tune the pre-trained LLM 126 into a finetuned LLM 128 for providing behavioral updates (e.g., learning a new skill) to the finetuned LLM 128, and after updates from the data sources 102 and 130 are used to update the RAG KBs via the CTE component 134, then queries received via the prompt interface undergo a two-step process where the query is first processed via the RAG KBs for generating augmented context for the query that will ultimately provide for filling informational gaps in the finetuned LLM 128, followed by appending the augmented context information from the RAG KBs to the query so that a combined query plus augmented context may be passed to the finetuned LLM 128 for receiving a response to the query.

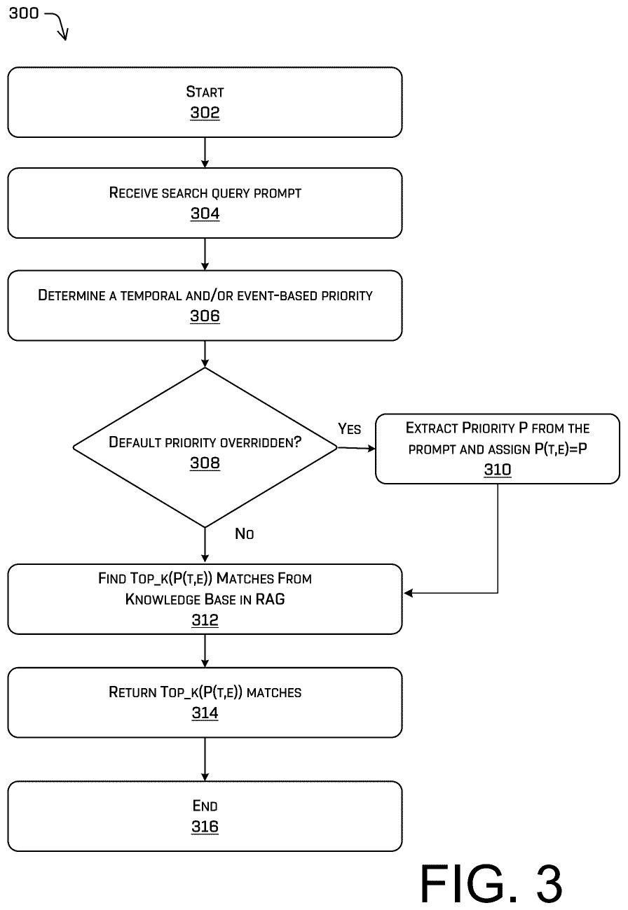

FIGS. 2, 3, 4 and 5 illustrate flow diagrams of example methods 200, 300, 400 and 500 that illustrate aspects of the functions performed at least partly by the devices, components and systems described in FIGS. 1A and 1B, such as the CTE component 134, DPSS component 136, RAG KBs 138 in association with the LLM 126 and finetuned LLM 128, and so forth. The logical operations described herein with respect to FIGS. 2 and 3 may be implemented (1) as a sequence of computer-implemented acts or program components running on a computing system and/or (2) as interconnected machine logic circuits or circuit components within the computing system.

The implementation of the various components described herein is a matter of choice dependent on the performance and other requirements of the computing system. Accordingly, the logical operations described herein are referred to variously as operations, structural devices, acts, or components. These operations, structural devices, acts, and components can be implemented in software, in firmware, in special purpose digital logic, and any combination thereof. It should also be appreciated that more or fewer operations might be performed than shown in the FIGS. 2, 3, 4 and 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 2 illustrates a flow diagram of an example method for updating a large language model based on post-training events or information and for dynamic prioritization of similarity search processes in vectorized knowledgebases. For purposes of example, the method illustrated in FIG. 2 shows updating the large language model and dynamic prioritization based on cybersecurity information updates and searches. In some instances, the operations of method 200 may be performed by a client device 148 that includes one or more processors and one or more non-transitory computer-readable media storing computer-executable instructions that, when executed by the one or more processors, cause the one or more processors to perform operations of method 300.

The method 200 begins at start operation 202 and proceeds to operation 204 where data from one or more of the data sources 104-118 is received at the pre-trained LLM 126. As described above, method 200 is illustrative of use of the functionality and systems described herein in an example cybersecurity management system where a cybersecurity operations person (SecOps) or other user may query a large language model (LLM) 126 for a response to a query.

Continuing with this example, at operation 204, information from the one or more data sources 104-118 is received at the pre-trained LLM 126. In any given instance in time, data may be passed from all available data sources 104-118, or alternatively, data may only be passed from one or more of the data sources 104-118 as required based on updates to the one or more data sources since the last update to the pre-trained LLM 126. If no data updates or changes have occurred in the data sources 104-118 since last update to the pre-trained LLM 126, then no data will be passed to the LLM 126 at operation 204. Alternatively, data from the one or more data sources 104-118 may be periodically or continuously fed into the LLM 126 regardless of known updates to data in any of the data sources 104-118.

At operation 206, data representing vulnerabilities 120 (CVEs), weaknesses 122 (CWEs), or other threats/relevant information 124 (OWASP) associated with the example cybersecurity management system may be passed to the pre-trained LLM 126 from the vulnerabilities, weaknesses, and system health source 130. For example, cybersecurity vulnerabilities and/or exposures recently encountered or determined may be passed to the pre-trained LLM 126 from the CVE source 120, one or more computer software weaknesses that may allow for cybersecurity threats may be passed to the pre-trained LLM 126 from the CWE 122, and information that may be utilized for improving cybersecurity may be passed to the pre-trained LLM 126 from the OWASP source 124.

As operation 208, data from the one or more data sources 104-118 and from the vulnerabilities, weaknesses, and system health source 130 may be used for finetuning the pre-trained LLM 126 into a finetuned LLM 128, as described above with reference to FIGS. 1A and 1B. For example, based on the finetuning process, the finetuned LLM 128 may be able to correlate information from various sources to assist in investigating one or more weaknesses on a specific asset graph (e.g., a representation of the various elements that comprise an application deployed on a cluster in the cloud along with corresponding posture). The finetuned LLM 128 may also be able to generate remediation code for some of any detected weaknesses, including configuration recommendations, patching scripts, etc. These new skills available from the finetuned LLM 128 may now be available to a querying SecOps person owing to the finetuning process of updating the pre-trained LLM 126 with information from the one or more data sources 104-118 and from the vulnerabilities, weaknesses, and system health source 130.

Referring back to operation 210, information from the one or more data sources 104-118 is received at the CTE component 134. At operation 212, data representing vulnerabilities 120 (CVEs), weaknesses 122 (CWEs), or other threats/relevant information 124 (OWASP) associated with the example cybersecurity management system may be passed to the CTE component 134 from the vulnerabilities, weaknesses, and system health source 130.

In operation 214, inputs received by the CTE component 134 from the one or more data sources 104-118 and/or from the vulnerabilities, weaknesses, and system health source 130 may be embedded and become part of the knowledgebases (KB) of the RAG KB 138. According to examples, inputs from the one or more data sources 104-118 and/or from the vulnerabilities, weaknesses, and system health source 130 may result in data embeddings applied to the RAG KBs. According to examples, the CTE component 134 may allow binding of the embeddings stored in vectorized databases with augmented metadata, thereby enabling the assignment of dynamic weights depending on temporal, and/or origin, and/or other contextual factors. At operation 216, different weights may be assigned to various occurrences of the same or similar string, and therefore, enable enhanced similarity searches for top k matches associated with same or similar strings.

After operation 216, the method 200 proceeds to operation 228, and embeddings generated and stored in the RAG KB 138 are bound with metadata associated with and describing the knowledgebase updates. The updated RAG KBs 138 are then available to the DPSS component 136 for retrieving augmented context information for the query received at operation 220. As described below, the augmented context information may then be used to append to the received query for passing to the finetuned LLM 128 as a combined query plus augmented context, as described above with reference to FIGS. 1A and 1B. The embeddings and subsequent updates of the RAG KBs may enable the SecOps person to benefit from the finetuned LLM 128 while investigating an alarm or notification. That is, the finetuned LLM 128 may enable the SecOps person to leverage new correlations, detections, and inference capabilities provided by the finetuned LLM 128 in concert with augmented context information from the RAG KBs 138.

At operation 218, a notification or alarm may be received at the client device 148, for example, an alarm providing an alarm code may be received. At operation 220, a user, for example, a cybersecurity operations person (SecOps), initiates a query to the finetuned LLM 128 about a given cybersecurity issue. According to examples, the query from the SecOps person may be the result of receipt of the notification or alarm, or the SecOps person may initiate the query independently of a notification or alarm where the SecOps person desires an answer to a response directed to the LLM 126 about a cybersecurity management system topic. According to an example, the SecOps person may send one or more queries through the prompt interface 140 via the client device 148 to investigate an issue or to conduct a root cause analysis process of a given issue, and in so doing, the SecOps person may leverage both the RAG KB 138 flows offered through the CTE component 134 as well as information presently available in the finetuned LLM 128.

For example, the SecOps person may initiate a query of “Why am I receiving security alarm error code 345?” According to examples, without use of the functionality and systems described herein, the pretrained LLM 126 may lack sufficient training to provide a response that is useful or even sensical. For example, if the information with which the pre-trained LLM 126 was pretrained did not include information that provides context for the query to allow an appropriate response to be generated, or if contextual information was pretrained into the LLM 126, but is information that is of an age that is no longer relevant to the query (e.g., information that lacks association with a recently updated API solution or updated application updates changes), then response from querying the LLM 126 may be lacking or even nonsensical.

At operation 222, the query received via the prompt interface 140 is temporarily stored at storage 142 while it awaits being appended with augmented context information from the RAG KBs 138 via the DPSS 136.

Referring back to operation 220, in addition to temporarily storing the received query at storage 142, the query is routed to the CTE component 134. When the query is forwarded to the CTE component 134, CTE component may then forward the query to the DPSS component 136 for further processing at operation 226. According to examples, at operation 228, the DPSS component 136 may perform similarity search and context retrieval from one or more of the RAG KBs. According to examples, the DPSS 136 may assist the CTE component 134 during the embedding and storage of information in the RAG KBs. In this case, the DPSS model 136 may support or maintain the metadata and associated bindings generated and applied to the data at the RAG KBs.

At operation 228, the DPSS component 136 performs a similarity search and context retrieval from the RAG KBs. At operation 230, the DPSS component 136 retrieves the top k matches based on the priority associated with the query. For example, as described above, the top k matches may be computed using a function of time (e.g., Top_k(P(t)). The top k matches may also be computed based on the weight of the events (e.g., Top_k(P (e)). They may also be computed as a function both of time and the weight of the events (e.g., Top_k(P(t,e)).

At operation 232, in response to the DPSS component 136 retrieval of the top k matches, prioritized search and augmented context information is appended to the temporarily stored original query received from the user (e.g., SecOps person) to generate the combined query (prompt) plus augmented context information 144. At operation 234, the DPSS component 136 passes the appended query to the finetuned LLM 128.

At operation 236, the combined query (prompt) plus augmented context information 144 (i.e., appended query) is received at the finetuned LLM 128. At operation 238, the finetuned LLM 128 generates a response 146 to the appended query. At operation 240, the response 146 is returned to the querying user (e.g., SecOps person) at the client device 148. Thus, as described herein, in response to the received query, the LLM 128 will be able to use one or more learned skills on updated information provided via the augmented context information. That is, after updates from the data sources 102 and 130 are used to fine tune the pre-trained LLM 126 into a finetuned LLM 128 for providing behavioral updates (e.g., learning a new skill) to the finetuned LLM 128, and after updates from the data sources 102 and 130 are used to update the RAG KBs via the CTE component 134, then queries received via the prompt interface undergo a two-step process where the query is first processed via the RAG KBs for generating augmented context for the query that will ultimately provide for filling informational gaps in the finetuned LLM 128, followed by appending the augmented context information from the RAG KBs to the query so that a combined query plus augmented context may be passed to the finetuned LLM 128 for receiving a response to the query. The method 200 ends at operation 242.

FIG. 3 illustrates a flow diagram of an example method for updating a large language model based on post-training events or information and for dynamic prioritization of similarity search processes in vectorized knowledgebases. For purposes of example the method illustrated in FIG. 3 shows the DPSS component 136 being utilized for a similarity search where the priority of data that may be returned based on similarity search may be a balanced function considering both the temporal relevance of events or data applied to the RAG KBs as well as the weights applied to the data items for which embeddings have been generated and applied in the RAG KBs.

The method 300 begins at start operation 302 and proceeds to operation 304 where a search query is received via the prompt interface 140 at the client device 148. As described above, the search query may be initiated by an operator via the prompt interface 140 owing to a notification received by the operator or based on an answer sought by the operator for a given question for which the LLM 126 and the subsequently finetuned LLM 128 have been trained and/or updated with data that may be responsive to the operator's query.

At operation 306, the DPSS component 136 may determine a temporal and/or event-based priority for data that may be responsive to the received query. For example, as briefly described above, a default priority may be assigned to a given data item considering both temporal relevance and weighting associated with the data item. That is, if a given data item was recently received and applied to the RAG KBs via the CTE component 134, and a weighting was applied to an occurrence of the data item, the combination of temporal relevance of the data item and the weighting assigned to the data item may be used for generating a default priority for the data item. The default priority may be utilized by the DPSS component 136 for selecting the data item as part of one or more returned matches for the received query from the RAG knowledgebase 138.

At operation 308, a determination may be made as to whether the default priority assigned to a given data item has been overridden. According to examples, the default priority may have been overridden where it may be known that more updated information may be available from one or more data sources 104-118 that may affect the temporal relevance of the data item (e.g., a newer data item that may be responsive to the query has been received since the last update of the finetuned LLM 128). Alternatively, or in addition to temporal relevance, the default priority may be overridden if a weighting associated with the new or updated data item causes the new or updated item to receive a higher weight than a previous instance of the data item for which the priority has been set.

If the default priority for a data item that may be responsive to the query has not been overridden, the method proceeds along the “No” branch to operation 312 where the DPSS component 136 finds the top k matches from one or more RAG knowledgebases (KB) based on the priority assigned to one or more data items in the RAG KB. Referring back to operation 308, if the default priority is overridden where it is determined that updates for data items contained in the RAG KBs have been received based on updated data from one or more of the data sources 104-118 or from the vulnerabilities, weaknesses and system health source 130, where the updated information may change the priority previously assigned to data items then the method proceeds to operation 310 where an updated priority is generated for the received query.

The method 300 then proceeds to operation 312 where the top k matches for data items associated with the updated priority are found from the RAG KBs. At operation 314, the top k matches returned for data items associated with either the default priority or an updated priority are returned in response to the received query. The method 300 ends at operation 316.

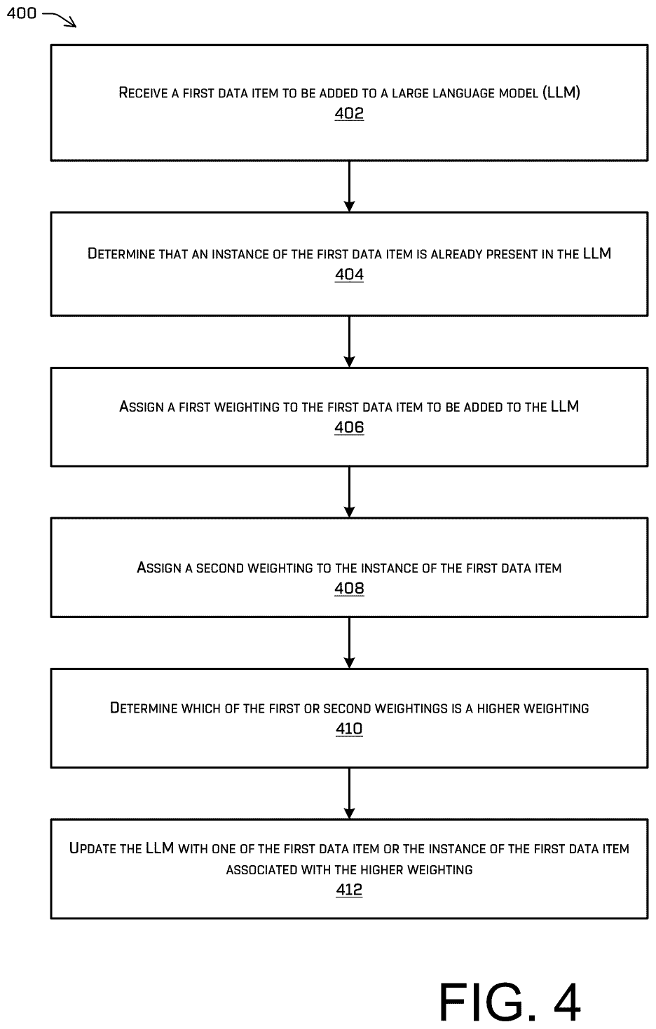

FIG. 4 illustrates a flow diagram of an example method 400 for dynamically updating a large language model (LLM) where a data item, for example, an application component update or security vulnerability or threat is received for updating the LLM, as described herein. When the data item is received, if a same or similar data item (for example, an instance of the received data item) is already present in the LLM, then weightings are applied to the data item and to the same, similar or instance of the received data item. Based on the weightings applied to the received data item and to the same, similar or instance of the received data item already present in the LLM, the data item with a higher weighting is used to update the LLM.

At operation 402, a first data item is received to be added to a large language model (LLM). According to examples, the first data item may include an update to an application component, one or more security vulnerabilities or threats, or other information applicable to the LLM.

At operation 404, a determination is made that a same, similar or an instance of the received first data item is already present in the LLM. According to examples described herein, the determination that a same, similar or instance of the received first data item is already present in the LLM may be performed after the received first data item is passed through the CTE component 134 and the DPSS component 136 in association with the RAG KBs 138.

At operation 406, a weighting is assigned to the received first data item at the RAG KBs 138 in association with the DPSS component 136, as described above with reference to FIGS. 1A and 1B.

At operation 408, a second weighting is assigned to the same, similar or instance of the received first data item in the same manner as the weighting is assigned to the received first data item.

At operation 410, a determination is made as to which of the received first data item or the same, similar or instance of the first data item is associated with a higher weighting. According to examples, the determination may be made by the DPSS component 136 in association with the CTE component 134 and the RAG KBs 138.

At operation 412, the LLM is updated with one of the received first data item or the same, similar or instance of the received first data item associated with a higher weighting.

In some cases, assigning the weightings to the received first data and to the same, similar or instance of the received first data includes binding embeddings to each of the received first data and to the same, similar, or instance of the first data item in vectorized databases that may be queried by the DPSS component 136, as described herein. In addition, the method 400 may include receiving a query that is applicable to the received first data item and to the same, similar or instance of the first data item and appending to the query augmented context information associated with the received first data item and the same, similar or instance of the first data item. The augmented context information appended to the query may be passed to the LLM so that a response to the query may be returned to in association with the received first data or the same, similar or instance of the first data item associated with a higher weighting.

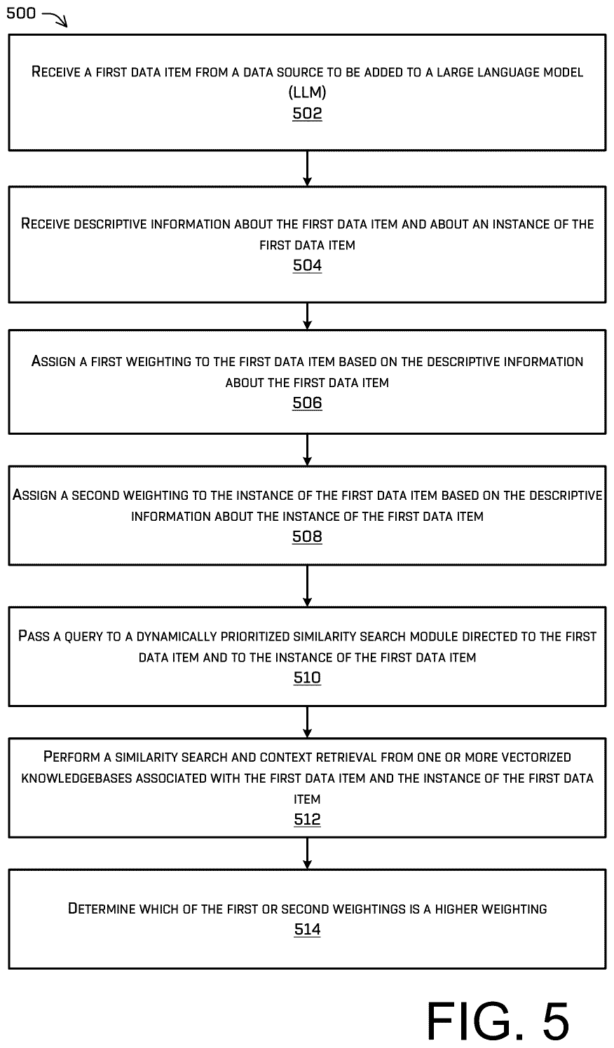

FIG. 5 illustrates a flow diagram of an example method 500 for dynamically prioritizing similarity searches directed to a large language model (LLM) by distinguishing between same or similar data items in a large language model based on weightings applied to same or similar data items.

At operation 502, the CTE component 134, described above with reference to FIGS. 1A and 1B is operative to receive a first data item from a data source to be added to a large language model (LLM).

At operation 504, the CTE component is further operative to receive descriptive information about the first data item and about a same, similar or instance of the received first data item. According to examples, descriptive information about the first data item and the same, similar or instance of the first data item may include timing associated with generation of the data items, timing associated with updates to the data items and one or more types of contextual information associated with the first data item or the same, similar or instance of the first data item, for example, previous updates made to the data items, security information, for example, vulnerabilities and threats associated with the data items, and the like.

At operation 506, the CTE component 134 or the DPSS 136 is operative to assign a weighting to the received first data item based on the descriptive information received for the first data item.

At operation 508, the CTE component 134 is operative to assign a second weighting to the same, similar or instance of the received first data item based on the descriptive information about the same, similar or instance of the received first data item.

At operation 510, the CTE component is further operative to pass a query to the dynamically prioritize similarity search (DPSS) component 136 directed to the received first data item and to the same, similar or instance of the received first data item.

At operation 512, the DPSS component 136 is operative to perform a similarity search and context retrieval from one or more vectorized knowledgebases associated with the received first data item and the same, similar or instance of the first-aid item.

At operation 514, the DPSS component 136 is further operative to determine which of the first or second weightings is a higher weighting.

In addition, according to some examples, the CTE component 134 is further operative to generate and bind embeddings in a vectorized knowledgebase associated with the received first data item and to generate and bind embeddings in a vectorized knowledgebase associated with the same, similar or instance of the received first data item. If a query is received that is applicable to the received first data item or to the same, similar or instance of the first data item, the query may be forwarded to the DPSS component 136, and the DPSS component 136 is operative to append the query with augmented context information associated with the embeddings and weightings applied to the received first data item and to the same, similar or instance of the first data item. The query along with the augmented context information may then be passed to the LLM for updating the LLM, as described herein.

FIG. 6 is a computer architecture diagram showing an illustrative computer hardware architecture for implementing a computing system/device that can be utilized to implement aspects of the various technologies presented herein. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a client device 148, the dynamic search system 100, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to start up the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 624. The chipset 606 can include functionality for providing network connectivity through a NIC 612, such as a gigabit Ethernet adapter. The NIC 612 is capable of connecting the computer 600 to other computing devices over the network 624. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program components, data structures, or other data. It should be appreciated by those skilled in the art that computer-readable storage media is any available media that provides for the non-transitory storage of data and that can be accessed by the computer 600. In some examples, the operations performed by the client device 148 and/or the dynamic search system 100, and or any components included therein, may be supported by one or more devices similar to computer 600. Stated otherwise, some or all of the operations performed by client device 148 and/or dynamic search system 100, and or any components included therein, may be performed by one or more computer devices 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1A-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a client device 148, the dynamic search system 100, and/or any other device. The computer 600 may include one or more hardware processors 604 (processors) configured to execute one or more stored instructions. The processor(s) 604 may comprise one or more cores. Further, the computer 600 may include one or more network interfaces configured to provide communications between the computer 600 and other devices, such as the communications described herein as being performed by the client device 148 or the dynamic search system 100. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for selectively encrypting the unencrypted portions of packets for transmission through an encrypted tunnel where the packets are at least partially encrypted. For instance, the programs 622 may cause the computer 600 to perform techniques for communicating determining that portions of the packets are already encrypted, identifying portions of the packets that are unencrypted, and selectively encrypting the portions of the packets that are unencrypted prior to transmission through the encrypted tunnel. In this way, potentially private or sensitive data in the packets that is unencrypted, such as information in the packet headers, will be encrypted using the encryption protocol of the encrypted tunnel, but the data of the packets that is already encrypted, such as the payload, may avoid unnecessary double encryption. By reducing (or eliminating) the amount of data in data packets that is double encrypted, the amount of time taken by computing devices, and computing resources consumed, to encrypted traffic for encrypted tunnels may be reduced. Additionally, the programs 622 may comprise instructions that cause the computer 600 to perform the specific techniques for receiving packets through the encrypted tunnel and decrypting portions of the packets using different encryption protocols.

While the invention is described with respect to the specific examples, it is to be understood that the scope of the invention is not limited to these specific examples. Since other modifications and changes varied to fit operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving a first data item to be added to a large language model (LLM);
determining that an instance of the first data item is present in the LLM;
assigning a first weighting to the first data item to be added to the LLM;
assigning a second weighting to the instance of the first data item;
determining which of the first or the second weightings is a higher weighting; and
updating the LLM with one of the first data item or the instance of the first data item associated with the higher weighting.

2. The method of claim 1, wherein:
assigning a first weighting to the first data item to be added to the LLM includes:
generating a first embedding in a first vectorized database, the first embedding associated with the first data item;
binding the first embedding to the first data item with augmented metadata associated with the first weighting assigned to the first data item;
assigning a second weighting to the instance of the first data item includes:
generating a second embedding in a second vectorized database, the second embedding associated with the instance of the first data item; and
binding the second embedding to the instance of the first data item with augmented metadata associated with the second weighting assigned to the instance of the first data item.

3. The method of claim 2, wherein the first and second embeddings trigger a continuous feeding of augmented metadata and associated embeddings for each of the first data item and the instance of the first data item into the LLM.

4. The method of claim 2, further comprising:
receiving a query where the query is applicable to the first data item and to the instance of the first data item;
querying the first and second vectorized databases for the first and second embeddings;
returning the first weighting assigned to the first data item;
returning the second weighting assigned to the instance of the first data item; and
returning one of the first data item or the instance of the first data item associated with the higher weighting.

5. The method of claim 4, further comprising:
appending the query with augmented context information associated with one of the first data item or the instance of the first data item associated with the higher weighting;
passing the augmented context information to the LLM;
querying the LLM with the appended query; and
returning a response from the LLM based on the appended query.

6. The method of claim 4, wherein returning one of the first data item or the instance of the first data item associated with the higher weighting includes determining which of the first or second weightings is a higher weighting according to a least one of:
determining which of the first or second weightings is a higher weighting based on a most recent time of generation;
determining which of the first or second weightings is a higher weighting is based on a higher priority origin of information; and
determining which of the first or second weightings is a higher weighting based on a higher vulnerability risk.

7. The method of claim 1, wherein after updating the LLM with one of the first data item or the instance of the first data item associated with the higher weighting, processing the first and second weightings according to at least one of:
resetting the first and second weightings after a determined period of time;
converging the first and second weightings into a single weighting; and
maintaining the first and second weightings until a condition is met.

8. The method of claim 1, wherein:
assigning a first weighting to the first data item to be added to the LLM includes assigning the first weighting to the first data item based on a time of generation of the first data item; and
assigning the second weighting to the instance of the first data item includes assigning the second weighting to the instance of the first data item based on a time of generation of the instance of the first data item.

9. The method of claim 8, wherein:
determining which of the first or second weightings is a higher weighting includes determining which of the first or second weightings is based on a most recent time of generation.

10. The method of claim 1, wherein:
assigning a first weighting to the first data item to be added to the LLM includes assigning the first weighting to the first data item based on a first origin of information describing the first data item; and
assigning the second weighting to the instance of the first data item includes assigning the second weighting to the instance of the first data item based on a second origin of information describing the instance of the first data item.

11. The method of claim 10, wherein:
determining which of the first or second weightings is a higher weighting includes determining which of the first or second weightings is based on a higher priority origin of information.

12. The method of claim 1, wherein:
assigning a first weighting to the first data item to be added to the LLM includes assigning the first weighting to the first data item based on a first vulnerability associated with the first data item; and
assigning the second weighting to the instance of the first data item includes assigning the second weighting to the instance of the first data item based on a second vulnerability associated with the instance of the first data item.

13. The method of claim 12, wherein:
determining which of the first or second weightings is a higher weighting includes determining which of the first or second weightings is based on a higher vulnerability risk.

14. A device comprising:
one or more processors; and
one or more non-transitory computer-readable media storing computer-executable instructions that, when executed by the one or more processors, cause the one or more processors to perform operations comprising:
receiving a first data item to be added to a large language model (LLM);
determining that an instance of the first data item is present in the LLM;
assigning a first weighting to the first data item to be added to the LLM;
assigning a second weighting to the instance of the first data item;
determining which of the first or second weightings is a higher weighting; and
updating the LLM with one of the first data item or the instance of the first data item associated with the higher weighting.

15. The device of claim 14, wherein:
assigning a first weighting to the first data item to be added to the LLM includes:
generating a first embedding in a first vectorized database, the first embedding associated with the first data item;
binding the first embedding to the first data item with augmented metadata associated with the first weighting assigned to the first data item;
assigning a second weighting to the instance of the first data item includes:
generating a second embedding in a second vectorized database, the second embedding associated with the instance of the first data item; and
binding the second embedding to the instance of the first data item with augmented metadata associated with the second weighting assigned to the instance of the data item.

16. The device of claim 15, further comprising:
receiving a query where the query is applicable to the first data item and to the instance of the first data item;
querying the first and second vectorized databases for the first and second embeddings;
returning the first weighting assigned to the first data item;
returning the second weighting assigned to the instance of the first data item; and
returning one of the first data item or the instance of the first data item associated with the higher weighting.

17. The device of claim 16, further comprising:
appending the query with augmented context information associated with the one of the first data item or the instance of the first data item associated with the higher weighting;
passing the augmented context information to the LLM;
querying the LLM with the appended query; and
returning a response from the LLM based on the appended query.

18. A system comprising:
a chunking, tokenization and embedding component operative:
to receive a first data item from a data source to be added to a large language model (LLM);
to receive descriptive information about the first data item and about an instance of the first data item;
to assign a first weighting to the first data item based on the descriptive information about the first data item;
to assign a second weighting to the instance of the first data item based on the descriptive information about the instance of the first data item;
to pass a query to a dynamically prioritized similarity search component directed to the first data item and to the instance of the first data item;
the dynamically prioritized similarity search component being operative:
to perform a similarity search and context retrieval from one or more vectorized knowledgebases associated with the first data item and the instance of the first data item; and
to determine which of the first or second weightings is a higher weighting.

19. The system of claim 18, wherein:
the chunking, tokenization and embedding component being further operative:
to generate a first embedding in a first vectorized knowledgebase, the first embedding associated with the first data item;
to bind the first embedding to the first data item with augmented metadata associated with the first weighting assigned to the first data item;
to generate a second embedding in a second vectorized knowledgebase, the second embedding associated with the instance of the first data item; and
to bind the second embedding to the instance of the first data item with augmented metadata associated with the second weighting assigned to the instance of the data item.

20. The system of claim 19, wherein:
the chunking, tokenization and embedding component being further operative:
to receive a query applicable to the first data item and to the instance of the first data item;
to forward the query to the dynamically prioritized similarity search component;
the dynamically prioritized similarity search component being further operative:
to query the first and second vectorized knowledgebases for the first and second embeddings;
to return the first weighting assigned to the first data item;
to returning the second weighting assigned to the instance of the first data item;
to return one of the first data item or the instance of the first data item associated with the higher weighting;
to append the query with augmented context information associated with the one of the first data item or the instance of the first data item associated with the higher weighting; and
to passing query with the augmented context information to the LLM.
